(19) United States
(12) Patent Application Publication
(10) Pub. No.: US 2019/0370894 A1
(43) Pub. Date: Dec. 5, 2019

(54) Systems, Methods, and Platform for Catastrophic Loss Estimation

(71) Applicant: Aon Global Operations Ltd. (Singapore Branch), Singapore (SG)

(72) Inventor: Anthony Meyers, Bloomington, MN (US)

(73) Assignee: Aon Global Operations Ltd. (Singapore Branch), Singapore (SG)

(21) Appl. No.: 16/428,306

(22) Filed: May 31, 2019

Related U.S. Application Data
(60) Provisional application No. 62/679,188, filed on Jun. 1, 2018.

(51) Int. Cl. G06Q 40/02; G06Q 40/08; G06F 16/9035; G06F 16/909; G06F 3/0482

(52) U.S. Cl. CPC G06Q 40/025; G06Q 40/08; G06F 3/0482; G06F 16/909; G06F 16/9035

(57) ABSTRACT

In an illustrative embodiment, systems and methods for assessing mortgage default risk due catastrophic event occurrences include receiving a loss determination query for a location, including a request for an assessment of mortgage default risk for properties within the location related to a type of catastrophic event. Estimated losses for the properties due to catastrophic event occurrences may be calculated from catastrophic risk models for the type of catastrophic event, and risk of mortgage default for the properties may be determined based on a comparison of the estimated losses to property equity variables such to an equity position, property value, and unpaid mortgage principal balance. A loss estimation user interface may be generated in real-time to present the estimated losses and the risk of mortgage default for the location.

### RELATED APPLICATIONS

This application claims priority to U.S. Provisional Patent Application Ser. No. 62/679,188, entitled “Systems, Methods, and Platform for Catastrophic Loss Estimation,” filed Jun. 1, 2018.

This application is related to the following prior patent applications directed to catastrophic risk estimation and management: U.S. patent application Ser. No. 13/804,505, entitled “Computerized System and Method for Determining Flood Risk,” filed Mar. 14, 2013; and U.S. patent application Ser. No. 15/460,985, entitled “Systems and Methods for Performing Real-Time Convolution Calculations of Matrices Indicating Amounts of Exposure,” filed Mar. 16, 2017. All above identified applications are hereby incorporated by reference in their entireties.

### BACKGROUND

The present technology relates to computing systems for quantifying risk of mortgages going into default for properties damaged by occurrences of natural or manmade catastrophic events (e.g., tornadoes, hurricanes, floods, wild fires, earthquakes, terrorist attacks, etc.).

It is known that models or other computer applications may be used to assess the potential liabilities of catastrophic events. Certain companies, such as insurance companies, may find information provided by these models/applications useful in determining their potential liability (i.e., risk exposure) based on the occurrence of the event. These models/applications use, generate and store large amounts of data that need to be processed and analyzed to facilitate the determination of its potential liabilities based on the event. Because many properties cans mortgages, occurrences of catastrophic events not only can cause physical damage to the property but can also cause an increased risk of mortgage default when physical damage costs cause reduction in property value or equity position. Because of the complex nature of the computations that are performed on vast amounts of data, it can be difficult for mortgage brokers and insurance providers to determine their risk exposure due to mortgage defaults caused by catastrophic events in a timely and efficient manner.

### SUMMARY OF ILLUSTRATIVE EMBODIMENTS

The forgoing general description of the illustrative implementations and the following detailed description thereof are merely exemplary aspects of the teachings of this disclosure, and are not restrictive.

In some embodiments, systems and methods for assessing mortgage default risk due to catastrophic event occurrences include receiving a loss determination query for a location, the loss determination query including a request for an assessment of mortgage default risk for properties within the location related to a type of catastrophic event. Estimated losses for the properties due to catastrophic event occurrences may be calculated from catastrophic risk models for the type of catastrophic event, and risk of mortgage default for the properties may be determined based on a comparison of the estimated losses to an equity position, property value, and unpaid mortgage principal balance. A loss estimation user interface screen may be generated in real-time to present the estimated losses and the risk of mortgage default for the location. The loss estimation user interface screen may be customized to a user submitting the loss estimation query.

In some embodiments, estimating losses for the properties due to the catastrophic event occurrences may include computing loss statistics for each property in a portfolio of mortgaged property locations. The losses may be estimated based on collateral allocations in which a first portion of a property collateral value is allocated to structure value and a second portion of the collateral value is allocated to land value. In some embodiments, exposure data indicating potential losses from at least one catastrophic event may be generated from a set of catastrophic event models supplied from one or more modeling vendors based on the collateral allocations. Based upon the loss estimations and equity position for each property in a given portfolio of properties, a determination may be made regarding whether a catastrophic event occurrence results in a mortgage default for the property. In some implementations, the mortgage default determinations for each of the properties may be used to calculate total estimated losses due to mortgage default.

In some embodiments, the estimated loss calculations can be used to generate a loss statistics matrix for a given portfolio or properties. The loss statistics matrix can be used to develop, in real-time responsive to a user request, a set of user interface screens presenting the loss statistics to a user in a predetermined format. In some embodiments, the user interface screens may dynamically present information customized to a user based on a particular portfolio or properties, type of catastrophic event, and/or preferred catastrophic event modeling vendor.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is a block diagram of an example environment for a catastrophic loss determination system;

FIG. 2 is a screen shot of an example catastrophic loss estimation input user interface screen;

FIG. 3 is a flow chart of an example method for performing loss and mortgage default calculations due to catastrophic event occurrences;

FIG. 4 is a diagram of example loss statistics categories for a loss matrix;

FIG. 5 is an example loss matrix including the loss statistics of FIG. 4;

FIGS. 6A-6B are screen shots of example loss statistic user interface screens;

FIGS. 7A-7B are screen shots of example loss statistic user interface screens;

FIGS. 8-11 are screen shots of example catastrophic loss estimation output user interface screens;

FIG. 12 is a block diagram of an example computing system; and

FIG. 13 is a block diagram of an example distributing computing environment including a cloud computing environment.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

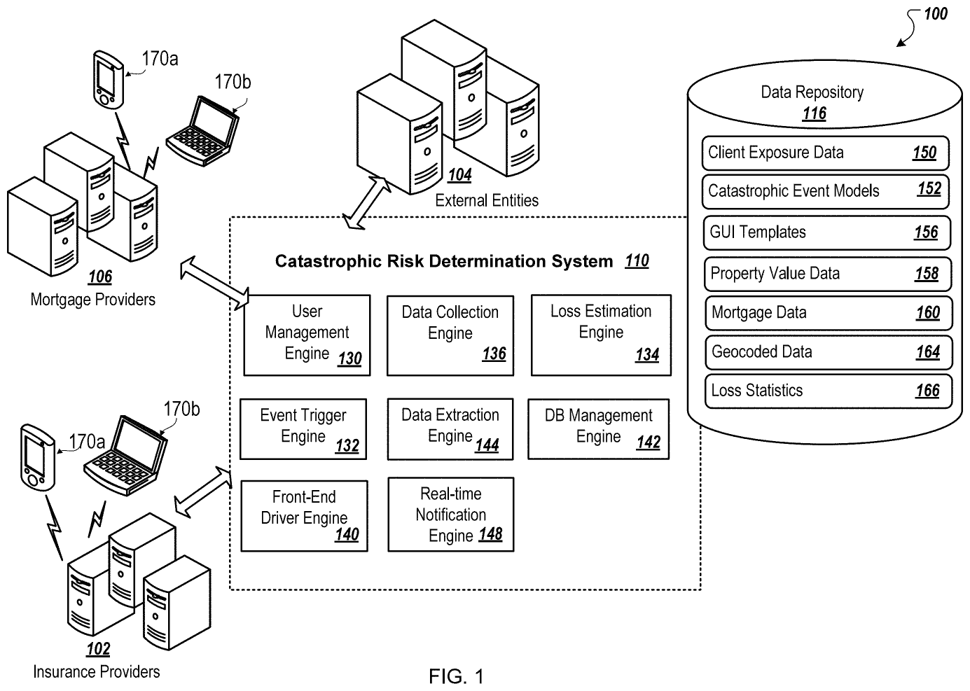

FIG. 1 is a diagram of an example environment 100 for a catastrophic loss determination system 110. The diagram illustrates relationships, interactions, computing devices, processing modules, and storage entities used to gather, generate, store, and distribute the information necessary to determine potential losses due to occurrences of catastrophic events (e.g., tornadoes, hurricanes, floods, wild fires, earthquakes, terrorist attacks), which can be used to determine costs associated with losses due to mortgage defaults from damage to properties caused by the catastrophic events. In some implementations, the information generated by the catastrophic loss determination system 110 can be used by insurance and/or reinsurance providers 102 as well as mortgage providers 106 to assess how catastrophic event occurrences may affect potential catastrophic insurance or property insurance claims as well as a severity associated with property owners defaulting on mortgages due to physical damage to a property caused by a catastrophic event. In some examples, the mortgage default severity determinations may be made based on a set of logical assumptions associated with mortgage default frequency based on physical loss modeling outputs received from catastrophic modeling vendors.

In some implementations, the catastrophic loss determination system 110 may gather and process information from external entities 104 such as catastrophic event model providers and property value providers in order to provide, in response to receiving a request, real-time catastrophic loss determinations to one or more insurance providers 102 (e.g., underwriters for catastrophic risk insurance and/or reinsurance policies) and/or one or more mortgage providers 106 (e.g., mortgage lenders or government-sponsored enterprises (GSEs) such as Fannie Mae or Freddie Mac). For example, the catastrophic loss determination system 110 can determine the severity of a mortgage default for a property due to the occurrence of a type of catastrophic event, such as an earthquake. The system 110 can also determine how a potential mortgage default affects overall losses due to the catastrophe occurrence.

In some examples, the insurance providers 102 may use the information output by the system 110 to determine whether or not to underwrite an insurance policy for a property at a particular location based on the potential loss amounts based on the severity of damage caused by the catastrophe. Additionally, the mortgage providers 106 may user the information provided by the system 110 to assess their own lending risk in light of the potential for various types of catastrophic event occurrences as well as make lending decisions based on the potential for mortgage default due to the potential for loss due to catastrophic events.

In certain embodiments, insurance providers 102 may connect to the catastrophic loss determination system 110 via a number of computing devices distributed across a large network that may be national or international in scope. The network of insurance providers 102 can be separate and independent from networks associated with other entities in the loss determination environment 100, such as the external entities 104 and mortgage providers 106. In addition, the data handled and stored by the insurance providers 102 may be in a different format than the data handled and stored by the other entities of the loss determination environment 100. The insurance providers 102 may include, in some examples, insured personnel, brokers, insurance/reinsurance carriers, or any other person providing inputs related to insurance coverage to the catastrophic loss determination system 110. For example, underwriters for insurance carriers who underwrite catastrophic event insurance policies for homeowners may input a query for a loss assessment for a set of one or more properties or generally over a geographic area (for example, a state, county, or postal code) due to a particular type of catastrophic event and receive, in real-time, a catastrophic loss assessment indicating physical damage costs, default loss amounts, probabilities of exceedance, and affected amounts of unpaid principal balance (UPB) for active mortgages when the loss occurs.

Additionally, the insurance providers 102 may also provide client exposure data 150 to the system 110, which may include characteristics and statistics associated an insurance policy portfolio of a particular insurance carrier or broker such as average and total coverage amounts, claims data, reinsurance statistics, and premium amounts. In other examples, the system 110 may automatically calculate portfolio statistics for a client in response receiving portfolio data file uploads from an insurance provider 102. In some examples, the client exposure data 150 may also include at least one type of preferred catastrophic risk model. Each type of catastrophic event, in some implementations, may have more than one catastrophic risk model and/or a blend of more than one model that can be used to calculate estimated losses due to catastrophic events. For example, any catastrophic risk model that includes event loss tables (e.g., year loss tables, period loss tables) can be used by the catastrophic loss determination system 110 to determine a risk of mortgage default due to occurrence of a catastrophic event. In some implementations, the system 110 can be configured to receive catastrophe modeling data from multiple catastrophe modeling vendors in multiple formats and manipulate the received data to calculate estimated losses due to catastrophic events.

External entities 104, in some implementations, include a number of computing devices distributed across a large network that may be national or international in scope. The network of external entities can be separate and independent from networks associated with other entities in the loss determination environment 100, such as the insurance providers 102 and mortgage providers 106. In addition, the data handled and stored by the external entities 104 may be in a different format than the data handled and stored by the other participants of in the loss determination environment 100. The external entities 104 can include any type of external system that provides data regarding catastrophic event occurrences such as government or private weather monitoring systems, first responder data systems, or law enforcement data systems. In some embodiments, external entities 104 may supply data into the risk determination system 110 (e.g., on a periodic basis or responsive to occurrence of a catastrophic event). In some embodiments, the risk determination system 110 connects to one or more external entities 104 to request or poll for information. For example, the risk determination system 110 may be a subscriber of information supplied by one or more of the external entities 104, and the risk determination system 110 may log into one or more of the external entities 104 to access information.

In some examples, the external entities 104 may include catastrophic event data providers such as the US Federal Emergency Management Agency (FEMA). Instead of or in addition to FEMA, the external entities 104 may also include other government agencies (of the US or another country) or may be nongovernmental public or private institutions that generate catastrophic event models 152 for any type of natural or manmade catastrophe. In an aspect where the catastrophic event is flooding, the external entities 104 may offer a specific set of flood risk products including, but not limited to, Flood Insurance Rate Maps (FIRMs) that may generally show base flood elevations, flood zones, and floodplain boundaries for specific geographic areas (the entirety of the US, for example). In some examples, the catastrophic event data providers may also offer periodic and/or occasional updates to catastrophic event models 152 due to changes in geography, construction and mitigation activities, climate change, and/or meteorological events. In some examples, the external entities 104 may also include catastrophic event model providers that generate commercial catastrophic risk modeling products from the data provided by the catastrophic event data providers.

In some implementations, the external entities 104 may also include property value providers that may provide inputs to the catastrophic loss determination system 110 that include property values for properties that are associated with received insurance applications. For example, property value data 158 received from the property value providers 106 may be based on public records (tax assessments, real estate sales, and the like), multiple listing service (MLS), or may be based on specific and, in some cases, proprietary appraisals of individual properties and/or groups of properties. In some examples, for each property, the property value data 158 may include a structure value and a land value that represent respective monetary values of a building structure and a plot of land for a given property. In some examples, the catastrophic loss determination system 110 may pull or extract property value data 158 from the property value providers using web harvesting or web data extraction from public or private websites. Alternatively, the catastrophic loss determination system 110 may operate under a contractual agreement with one or more property value providers to provide property value data 158. The property value data 158 may also be provided by the insurance providers 102 as part of an insurance policy application.

Mortgage providers 106, in some implementations, include a number of computing devices distributed across a large network that may be national or international in scope. The network of mortgage providers 106 can be separate and independent from networks associated with other entities in the loss determination environment 100, such as the insurance providers 102 and external entities 104. In addition, the data handled and stored by the mortgage providers 106 may be in a different format than the data handled and stored by the other participants of in the loss determination environment 100. The mortgage providers 106 can include any type of mortgage lender, which may include banks, brokerages, and GSEs that purchase mortgages from lenders and package them into mortgage-backed securities (MBSs), which are backed by the government. For example, mortgage lenders may also input queries for loss assessments of a set of properties in a portfolio of mortgages or generally over a geographic area due to a particular type of catastrophic event and receive, in real-time, a catastrophic loss assessment indicating physical damage costs, default loss amounts, probabilities of exceedance, and affected amounts of UPB for active mortgages when the loss occurs.

Similar to the insurance providers 102, the mortgage providers 106 may also provide client exposure data 150 to the system 110, which may include characteristics and statistics associated with a portfolio of mortgages maintained by each of the mortgage providers 106. In some implementations, the mortgage characteristics and statistics may include UPBs, term, and loan-to-value (LTV) ratios for each of the loans in the mortgage portfolio within a designated geographic region. In other examples, the system 110 may automatically calculate portfolio statistics for a client in response receiving portfolio data file uploads from a mortgage provider 106 and using additional data from the data repository, such as property value data 158 received from a property value provider.

In some embodiments, the catastrophic loss determination system 110 may include one or more engines or processing modules 130, 132, 134, 136, 140, 142, 144, 148 that perform processes associated with determining losses due to catastrophic events causing mortgage defaults in response to a query received from an insurance provider 102 or mortgage provider 106. In some examples, the processes performed by the engines of the catastrophic loss determination system 110 can be executed in real-time in order to provide an immediate response to a system input. In addition, the processes can also be performed automatically in response to a process trigger that can include a specific day or time-of-day or the reception of data from a data provider (e.g., one of the external entities 104 such as a catastrophic event model provider or property value provider), one of the insurance providers 102, one of the mortgage providers 106, or another processing engine.

In some implementations, the catastrophic loss determination system 110 may include a user management engine 130 that may include one or more processes associated with providing an interface to interact with one or more users (e.g., individuals employed by or otherwise associated with insurance providers 102 or mortgage providers 106) within the loss determination environment 100. For example, the user management engine 130 can control connection and access to the catastrophic loss determination system 110 by the insurance providers 102 and mortgage providers 106 via authentication interfaces at one or more external devices 170 of the insurance providers 102 and mortgage providers 106. In some examples, the external devices 170 may include, but are not limited to, personal computers, laptop/notebook computers, tablet computers, and smartphones.

The catastrophic loss determination system 110, in certain embodiments, may also include a data collection engine 136 that controls the gathering of data from the external entities 104 such as the catastrophic model providers and property value providers. In some examples, the data collection engine 136 can typically receive data from one or more sources that may impact loss determinations in response to queries from insurance providers 102 or mortgage providers 106. For example, the data collection engine 136 can perform continuous, periodic, or occasional web crawling processes to access updated data from the external entities 104.

In addition, the catastrophic loss determination system 110 may include, in some implementations, a database management engine 142 that organizes the data received by the catastrophic loss determination system 110 from the external entities 104. In some examples, the database management engine 142 may also control data handling during interaction with insurance providers 102 and/or mortgage providers 106. For example, the database management engine 142 may process the data received by the data collection engine 136 and load received data files to data repository 116, which can be a database of data files received from the one or more data sources. In one example, the database management engine 142 can determine relationships between the data in data repository 116. For example, the database management engine 142 can link and combine received property value data 158 with geocoded data 164 associated with the properties. In addition, the database management engine 142 may perform a data format conversion process to configure the received data into a predetermined format compatible with a format of the files within data repository 116.

In some implementations, the catastrophic loss determination system 110 may also include a real-time notification engine 148 that ensures that data input to the catastrophic loss determination system 110 is processed in real-time. In addition, the processes executed by the real-time notification engine 148 ensure interactions between the insurance providers 102, mortgage providers 106, and the catastrophic loss determination system 110 are processed in real-time. For example, the real-time notification engine 148 may output alerts and notifications to the insurance providers 102 and/or mortgage providers 106 via user interface (UI) screens when data associated with the insurance providers 102 or mortgage providers 106 have been received by the data collection engine 136.

In some examples, the catastrophic loss determination system 110 may also include an event trigger engine 132, which can manage the flow of data updates to the catastrophic loss determination system 110. For example, the event trigger engine 132 may detect updates to catastrophic event models 152, property value data 158, mortgage data 160, geocoded data 164, or any other type of data collected or controlled by the catastrophic loss determination system 110. The event trigger engine 132 may also detect modifications or additions to the files of the data repository 116, which may indicate that new or updated data has been received. When a data update is detected at data repository 116, the event trigger engine 132 loads the updated data files to a data extraction engine 144. The event trigger engine 132 operates in real-time to update the data extraction engine 144 when updated data is received from the data sources. In addition, the event trigger engine 132 operates automatically when updated data is detected at the data repository 116. In addition, the data extraction engine 144 extracts data applicable to the catastrophic loss determination system 110 from data files received from the data sources.

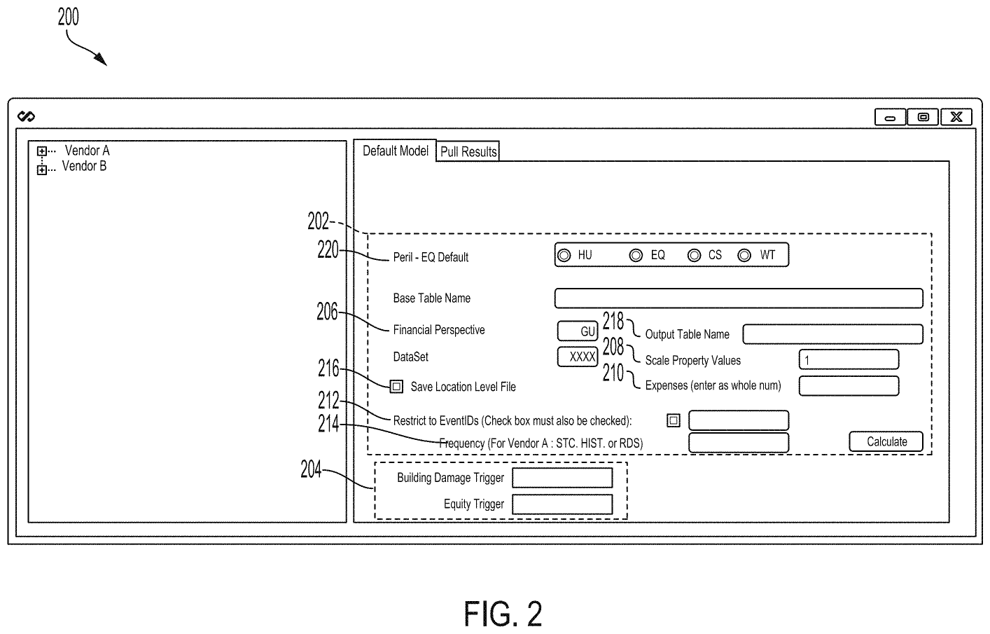

In some implementations, the catastrophic loss determination system 110 may also include a front-end driver engine 140 that controls dissemination of data and interactions with insurance providers 102 and mortgage providers 106 through one or more UI screens that may be output to the external devices 170 in response to queries received from the insurance providers 102 and/or mortgage providers 106. For example, the insurance providers 102 and mortgage providers 102 may provide query input parameters at a UI screen, which may include type of catastrophe, file names for input and output loss tables, building damage trigger amount, and equity trigger amount (see FIG. 2). In addition to the query input parameters, the insurance providers 102 and/or mortgage providers 106 can provide property and/or mortgage information for properties associated with an insurance or mortgage portfolio.

In response to receiving the inputs at the UI screen, the front-end driver engine 140 may output, in real-time, aggregated loss statistics 166 for the properties indicated in the query, which may include all properties within a particular geographic region. For example, the loss statistics 166 may include physical damage costs, default loss amounts, probabilities of exceedance, and affected amounts of unpaid principal balance (UPB) for active mortgages when the loss occurs. In other examples, the loss statistics 166 may be output to the external devices 170 of the insurance providers 102 and/or mortgage providers 106 as a series of loss reports. In some implementations, the loss statistics may be stored in the data repository 116 as loss vectors in which the loss vector includes entries of loss statistics for each property in an insurance or mortgage portfolio. The loss vectors can also be referred to interchangeably as loss matrices throughout the disclosure.

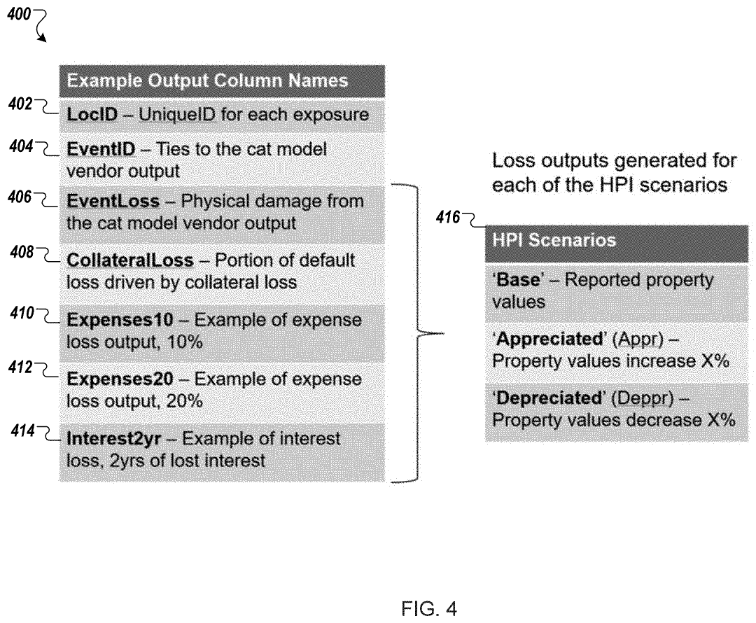

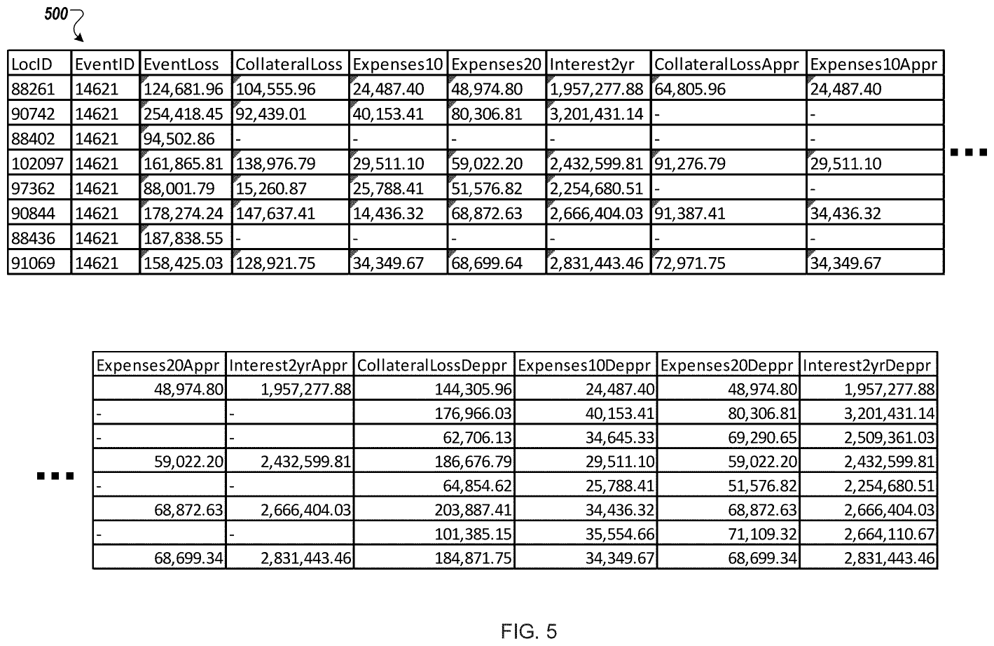

In some implementations, the front-end driver engine 140 may cause geocoded data 164 (e.g., maps corresponding to a location of an indicated property in the submitted application) to be dynamically displayed on a front-end UI to allow users to interact with the information stored in the data repository 116. In some implementations, the database (DB) management engine 142 links the geocoded data for a particular location to a corresponding loss vector for an insurance provider 102 and/or mortgage provider 106, which improves the processing efficiency of presenting estimated losses and mortgage default risk information to users within UI screens. For example, data points associated with locations properties affected or damaged by a catastrophic event may be plotted on a map displayed within a UI screen. In some embodiments, the data points may be color coded to indicate whether the mortgage for a property would default due to the catastrophic event occurrence (see FIGS. 4-5). In one example, the front-end of the catastrophic loss determination system 110 may be implemented as a web application that a user (e.g., insurance provider 102) accessed through a web browser running on external devices 170. In some embodiments, the front-end of the system 110 may also be a full-fledged application or mobile app that runs on external devices.

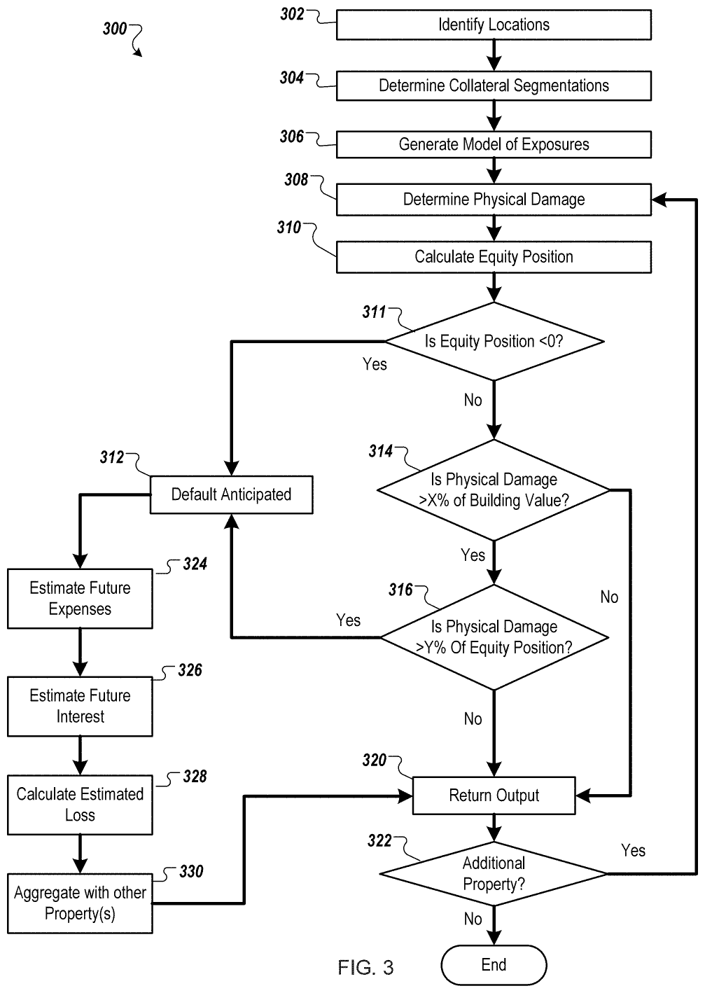

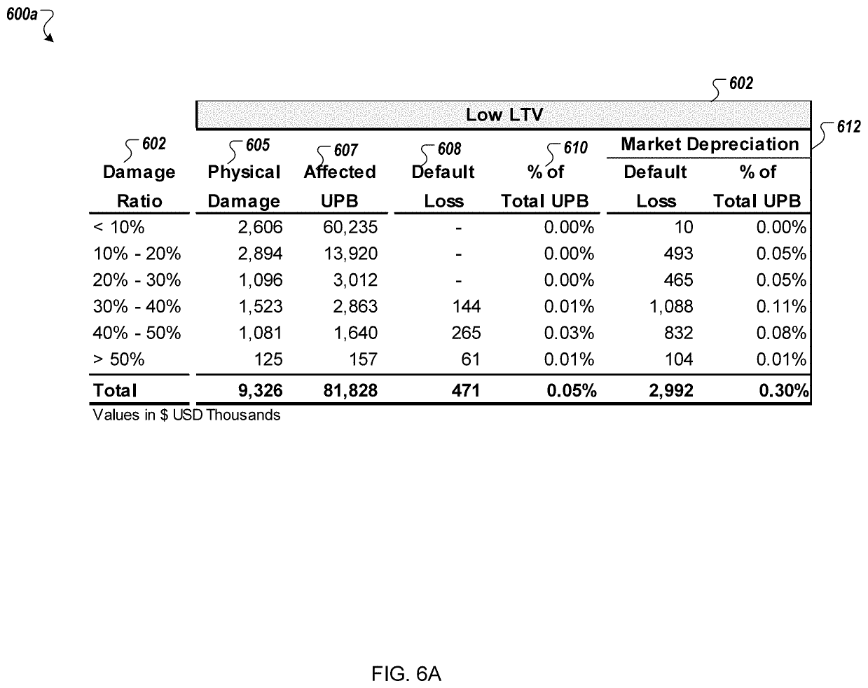

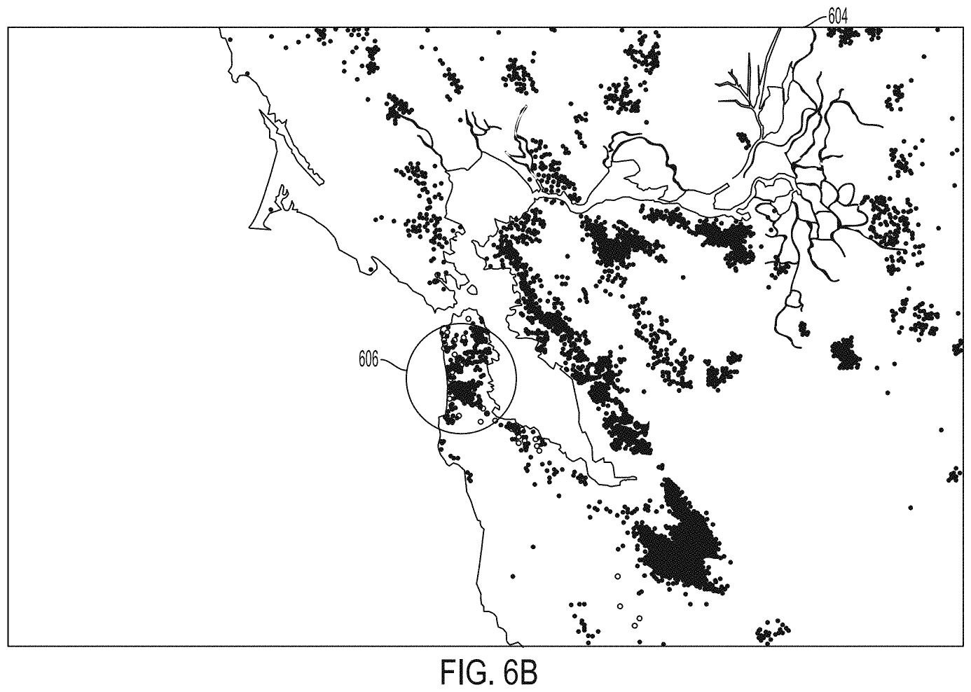

In some implementations, the catastrophic loss determination system 110 may also include a loss estimation engine 134 that computes loss amounts due to property damage from catastrophic events and also determines the effects that the loss amounts have on mortgages for affected properties by calculating loss statistics associated with catastrophic event occurrences. For example, the loss estimation engine 134 may use catastrophic risk models to calculate, for different types of catastrophic events, probabilities of exceeding certain loss thresholds, corresponding return periods, and amounts and percentages of physical damage to properties. Based on the calculated loss amounts due to physical damage, the loss estimation engine 134 can also calculate affected unpaid principal balance (UPB) for damaged properties carrying a mortgage during occurrence of a catastrophic event and amounts of loss due to mortgage default. In some examples, the loss estimation engine 134 can also calculate default loss and percentages of affected UPB due to market depreciation caused by occurrences of catastrophic events. In some implementations, the loss statistics calculated by the loss estimation engine 134 may be transmitted to the front-end driver engine 140 for presentation within one or more user interface screens and/or results reports that are output to the external devices 170 of the insurance providers 102 or mortgage providers 106. In some implementations, the loss estimation engine 134 configures and stores the calculated loss statistics 166 in a predetermined matrix format (see FIGS. 4-5) that provides for generating a variety of outputs (see FIGS. 6A-11) in real-time by the front-end driver engine 140 in response to user requests. In this way, the catastrophic loss system 110 provides a technical solution to a technical problem because the specific loss statistics that are calculated and specific data structures that store the loss statistics enable the system 110 to more efficiently determine whether risks of catastrophic loss will impact mortgage losses for a particular insurance provider 102. Further, the implementations described herein provide the ability to customize the loss estimation and mortgage risk assessments to the preferences and unique portfolio characteristics of insurance providers 102 and/or mortgage providers 106 and provide results in real-time without incurring additional processing costs, which was not possible using conventional methods. Details regarding the functionality of the loss estimation engine 134 are described below (FIG. 3).

Turning to FIG. 2, a screen shot of an example catastrophic loss estimation input user interface screen 200 is illustrated. In some implementations, the user interface screen 200 includes a number of input parameter fields 202 that allow insurance providers 102 and/or mortgage providers 106 to provide input parameters and input data that can be used to calculate estimated losses due to catastrophic event occurrences. In some examples, the input parameter fields 202 allow the catastrophic loss determination system 110 to customize loss vectors generated by the loss estimation engine 134 to the preferences of the insurance providers 102 and/or mortgage providers 106. For example, one of the input parameter fields 202 may allow users to indicate a type of catastrophic event 220, such as hurricane (HU), earthquake (EQ), convective storm (CS), and winter storm (WT). In one example, if an input is not provided for the catastrophic event type, then a default event type (for example, an earthquake) can be assumed. In some implementations, the input parameter fields 202 may also allow users to indicate a preferred catastrophic event model 152, provide data file input information 218 (e.g., file name, storage location) for a location data set to be analyzed, and designate a file name for the loss statistics 166 generated by the catastrophic loss determination system 110. In some examples, the location data set may include property value data 158, mortgage data 160, and geocoded data 164 for one or more locations associated with a mortgage or insurance portfolio. In another example, the locations may correspond to a particular region such as a state, county, or postal code.

In some implementations, the input parameter fields 202 may include a financial perspective field 206 that indicates a particular financial perspective for the catastrophic models that are used to perform loss estimations. For example, the financial perspectives may include ground-up (100% physical loss), gross (physical loss net of deductibles and limits), and net pre-cat (physical loss net of deductibles, limits, and underlying reinsurance). The input parameter fields 202 may also include a scale property value input 208 that allows users to indicate a property value scaling factor, which can be used to scale property values up and down to reflect market appreciation or depreciation. For example, in a scaled down implementation, more mortgage defaults may occur because an equity default threshold can be triggered more often. Similarly, in scaled up implementations, fewer mortgage defaults may occur. An expense input field 210 allows users to input expense assumptions by mortgage carrier, which can provide flexibility surrounding the expense severity used in loss calculations.

Further, the input parameter fields 202 may include an event identification restriction selector 212 that provides for segmenting an output results set to specified events versus an entire stochastic event set. In some examples when AIR catastrophic event models are used, the input data fields 202 may also include frequency inputs 214 that allow a user to specify a frequency class for segmenting events in a result set (e.g., stochastic (STC), historical (HIST), realistic disaster scenario (RDS).) Additionally, the input data fields 202 may include a save location level file selector 216 that causes the system 110 to save the mortgage default loss results calculated by the system 110 at an event level to conserve storage space in the data repository 116. In some implementations, the system 110 can roll the generated outputs up to the event level rather than as a three-dimensional matrix that includes a location identifier, event, and default loss calculation for each location in an insurance portfolio.

In some implementations, the UI screen 200 may also include threshold input fields 204 that can be used by the catastrophic loss determination system 110 for the loss estimation calculations. For example, a building damage trigger may provide a minimum threshold amount of loss that indicates significant building damage caused by a catastrophic event. Additionally, an equity trigger may indicate a minimum threshold amount of loss that corresponds to a mortgage default due to a catastrophic event. In some examples, the inputs provided at the input parameter fields 202 and threshold input fields 204 are used by the system 110 to perform loss and mortgage default calculations in response to submission of the inputs 202, 204 as a query at the UI screen 200.

For example, FIG. 3 illustrates a flow chart of an example method 300 for performing loss and mortgage default calculations due to catastrophic event occurrences. In some examples, the method 300 is performed by the catastrophic loss determination system 110 in response to submission of a loss estimation query at the catastrophic loss estimation input user interface screen 200. In some embodiments, the method 300 is performed by loss estimation engine 134. In one example, the loss calculations may be performed using catastrophic event models 152 from one or more catastrophic event model providers and mortgage data 160 received from mortgage providers 106.

In some implementations, the method 300 commences with identifying one or more locations associated with a loss estimation query (302). The locations, in some examples, may correspond to properties in a mortgage or insurance portfolio or may encompass all properties within a geographic region, such as a state, county, or postal code. In some implementations, collateral segmentations for each of the locations may be determined (304). In some examples, determining the collateral segmentation can include allocating a first portion of a property collateral value to structure value and a second portion of the collateral value to land value. In one example, the first and second portions of the collateral value allocated to each of the structure value and land value may correspond to respective fractions of the total property value 158 that represent each of the structure value and land value of the property. In some implementations, the collateral value is segmented into a structure value and a land value because the catastrophic risk models are calibrated on structural damage and do not include damage to land (e.g., fissures and cracks from an earthquake).

In some implementations, catastrophic exposure models can be generated for the locations due to occurrences of at least one catastrophic event (306). In some examples, the catastrophic exposure models can be generated from catastrophic risk models received from catastrophic risk model providers. For example, exposure data (e.g., a structure value and associated risk characteristics) for a location can be processed by catastrophic risk modeling software to generate a risk model for the exposure data, which can include loss values for the location due to a particular catastrophic event. In some examples, the catastrophic risk modeling software can generate an exposure data set that represents estimated losses for the location due to the catastrophic event.

In some examples, for each of the locations, an amount of physical damage to the location is determined by the loss estimation engine 134 based on the generated exposure model (308). In some embodiments, the loss estimation engine 134 may calculate an equity position estimate for the location by subtracting an amount of unpaid principal balance (UPB) for the property from a collateral value for the property to (310). In some implementations, if the calculated equity position is less than zero (311), then mortgage default may be anticipated (312). If, in some implementations, the physical damage to a building at the location is greater than a building value (structure value) threshold percentage (X%) (314), and the physical damage is greater than an equity threshold percentage (Y%) (316), then mortgage default may also be anticipated (312). In some examples, the building damage threshold and equity threshold values may correspond to the equity trigger value input and building damage trigger value input at the threshold input fields 204 in the UI screen 200 (FIG. 2).

In instances where default is anticipated (312) based upon the equity position being less than zero (311) and/or the physical damage being greater than a building value trigger and/or an equity threshold trigger (314, 316), the loss estimation engine 134 may calculate an estimated total loss (328) based upon estimated future expenses (324) and future interest (326) caused by the catastrophe-caused mortgage default. In some implementations, for each property that is processed, the loss estimation engine 134 may return one or more loss values for the property (320). In one example, the loss values may be generated in vector form that can be stored as a row in an output table for the client exposure data 150. For example, the vector of loss values for a given property may include entries for a loss identifier, a catastrophic event identifier, and a default loss amount in dollars (see FIGS. 4-5). In some implementations, if a default is not anticipated (for example, “No” at 318), then the default loss amount may be $0. In instances where a mortgage default is anticipated (for example, “Yes” at 308, 314, 318), then in some examples, the default loss amount may be calculated as follows: Loss=(Physical Damage+Expenses+Delinquent Interest)−Equity Position. In some examples, the estimated losses may be aggregated with other properties in a set of locations being processed (e.g., in a mortgage or insurance portfolio) (330), and if there are any additional properties in the set of locations to be processed (322), then the loss estimation engine 134, in some examples, determines the physical damage of the next property for processing (308).

Although illustrated in a particular series of events, in other implementations, the steps of the loss and mortgage default calculation process 300 may be performed in a different order. For example, generating an exposure model (306) may be performed before, after, or simultaneously with estimating calculating an equity position of a location (310). Further, default anticipating calculations (e.g., determining whether an equity position is less than zero (311), whether physical damage is greater than a building value threshold (314), or whether the physical damage is greater than an equity position threshold (316)) for multiple properties in a set of locations can be performed simultaneously. Additionally, in other embodiments, the process may include more or fewer steps while remaining within the scope and spirit of the loss and mortgage default calculation process 300.

Turning to FIGS. 4-5, an example loss statistics matrix is illustrated. FIG. 4 shows an example set of loss statistics categories 400 for a loss matrix 500 (FIG. 5) of a credit portfolio of property locations that may be exposed to catastrophic events. In some implementations, the loss matrix 500 may be generated by the loss estimation engine 134 through execution of the loss and mortgage default calculation process 300 (FIG. 3) and transmitted to the front-end driver engine 140 for presentation of the loss statistics 166 in one or more user interface screens (for example, user interface screens illustrated in FIGS. 6A-11) in real-time in response to a user request. As shown in FIG. 4, the loss statistics categories 400 may include a location identification (ID) 402, which is a unique identifier for each exposure within a portfolio as well as a catastrophic event ID 404, which is associated with a catastrophic event model from a particular vendor.

In some implementations, for each location ID 402 and event ID 404 in a given portfolio, the loss matrix 500 may include monetary amounts for physical damage from the catastrophic model vendor output 406 (EventLoss), a portion of the default associated with collateral losses 408 (CollateralLoss), percentage expense loss outputs at different percentage tiers 410, 412 (Expenses10, Expenses20), and interest loss amount over a predetermined period of time, such as two years 414 (Interest2yr). In some examples, loss statistics 166 for the categories 406-414 may be generated for multiple housing price index (HPI) scenarios 416. In one example, the HPI scenarios may include a base scenario at the reported property value, an appreciated scenario at a percentage increase in property value, and a depreciated scenario at a percentage decrease in property value. In some examples, the HPI scenarios that are computed may be based on the user-provided scale property value input 208 at user interface screen 200 (FIG. 2). In other examples, the loss estimation engine 134 can compute any combination of HPI scenarios (base, appreciated, and depreciated) at a default percentage change amount. The generated loss matrix 500 may be stored as a SQL table as part of the loss statistics in the data repository 116 (FIG. 1). In some implementations, the loss estimation engine 134 can also include mortgage loss statistics for each of the portfolio locations such as default loss amount, affected UPB, loss percent of total UPB, and LTV ratio.

In addition, the loss matrix 500 can be used to by the front-end driver engine 140 to develop output UI screens that present customized information to a user based on a particular portfolio or properties, type of catastrophic event, and/or preferred vendor model. In some implementations, the customization can be further based on inputs provided by a user at the user interface screen 200 (FIG. 2). In this way, the system 110 provides a technical solution to the technical problem of automating the generation of customized graphical user interface screens that are tailored to a user's (e.g., insurance provider 102 and/or mortgage provider 106) portfolio characteristics and preferences. By structuring the loss matrix 500 in the predetermined format, the system 110 can generate the customized GUI screens in real-time regardless of a size of portfolio, location, and/or number and type of catastrophic risk models used to perform the risk exposure analysis.

Turning to FIGS. 6A-11, screens shot of example catastrophic loss estimation output user interface screens are illustrated. In some implementations, the loss estimation engine 134 may calculate loss statistics 166 for the aggregated losses determined through execution of the loss and mortgage default calculation process 300. In some implementations, the front-end driver engine 140 may dynamically present some or all of the features displayed in the UI screens 600, 700, 800, 900, 1000, 1100 of FIGS. 6A-11 within one or more customized UI screens. In some examples, generation of a loss matrix 500 (FIG. 5) by the loss estimation engine 134 that includes calculated loss statistics for a number of property locations in a mortgage or insurance portfolio allows the front-end driver engine 140 to dynamically present the loss statistics to users in real-time in a number of different user interface screen formats.

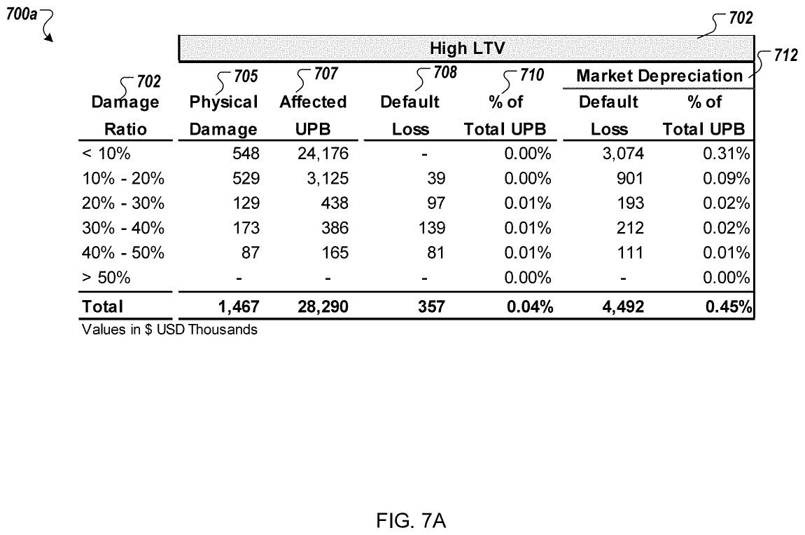

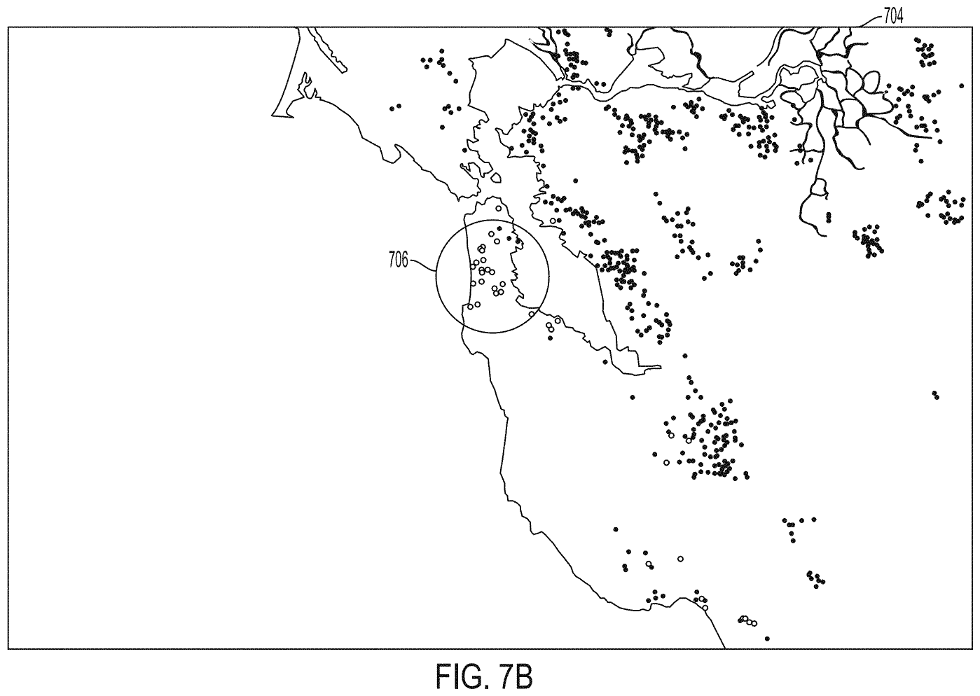

For example, FIGS. 6A-6B and 7A-7B illustrate output UI screens 600 and 700 presented dynamically in real-time by front-end driver engine 140 that include tables of loss statistics 602, 702 as well as geographic representations of defaulted and non-defaulted mortgages 604, 704 for low loan-to-value (LTV) and high LTV mortgages, respectively. In some examples, the front-end driver engine 140 can break up the presented loss results into multiple UI screens based on the LTV ratios for the mortgages in an insurance portfolio as shown in FIGS. 6A-6B and 7A-7B (e.g., low LTV, high LTV). In some implementations, for ranges of physical damage ratios associated with a set of properties, the tables of loss statistics 602, 702 may include physical damage amounts 605, 705, affected UPB amounts 607/707, default loss amounts 608/708, percentage of total UPB 610/710, and default loss and percentages of affected UPB due to market appreciation and/or depreciation 612/712. In some embodiments, the geographic representations of defaulted and non-defaulted mortgages 604, 704 may display each property location as a data point that is color coded based on whether the mortgage defaulted due to a catastrophic event occurrence or not. In some examples, the front-end driver engine 140 may also dynamically highlight one or more regions 606, 706 on the graphical representations 604, 704 that correspond to areas with relatively higher proportions of defaulted mortgages. In one example, the front-end driver engine 140 may highlight the proportionally higher default regions 606, 706 by applying a highlighted border around the affected regions 606, 706.

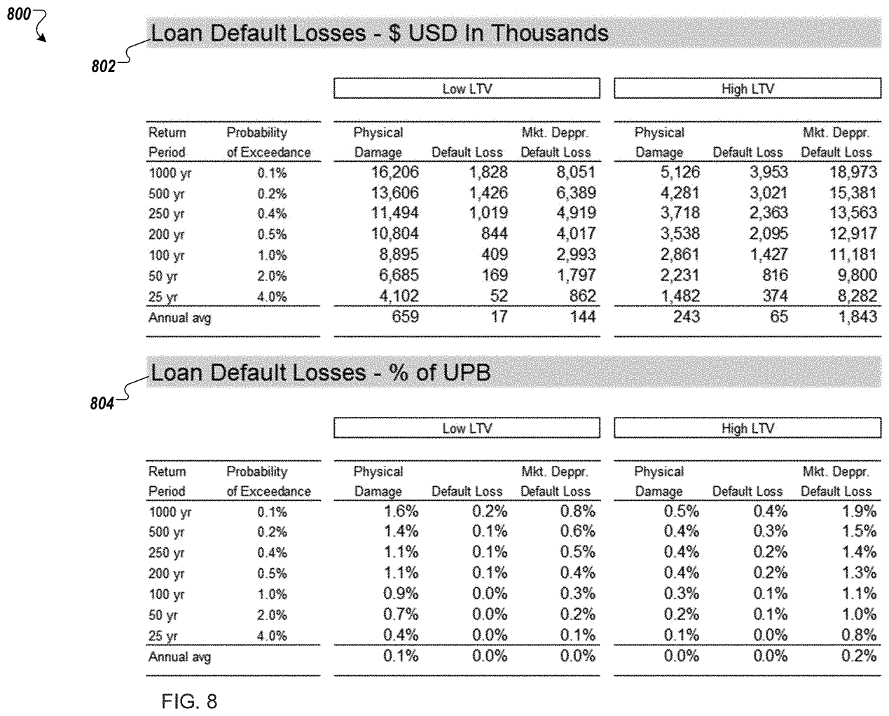

FIG. 8 illustrates a screen shot of another output UI screen 800 dynamically presented to a user by the front-end driver engine 140 in real-time from a loss matrix 500 generated by loss estimation engine 134. In some examples, the UI screen 800 displays loss statistics for a set of locations with respect to return period/probability of exceedance (the return period corresponds to the reciprocal of the probability of exceedance). In some implementations, the loss statistics may be displayed in thousands of dollars 802, in percentage of UPB 804, and/or in other units such as base points (BPS).

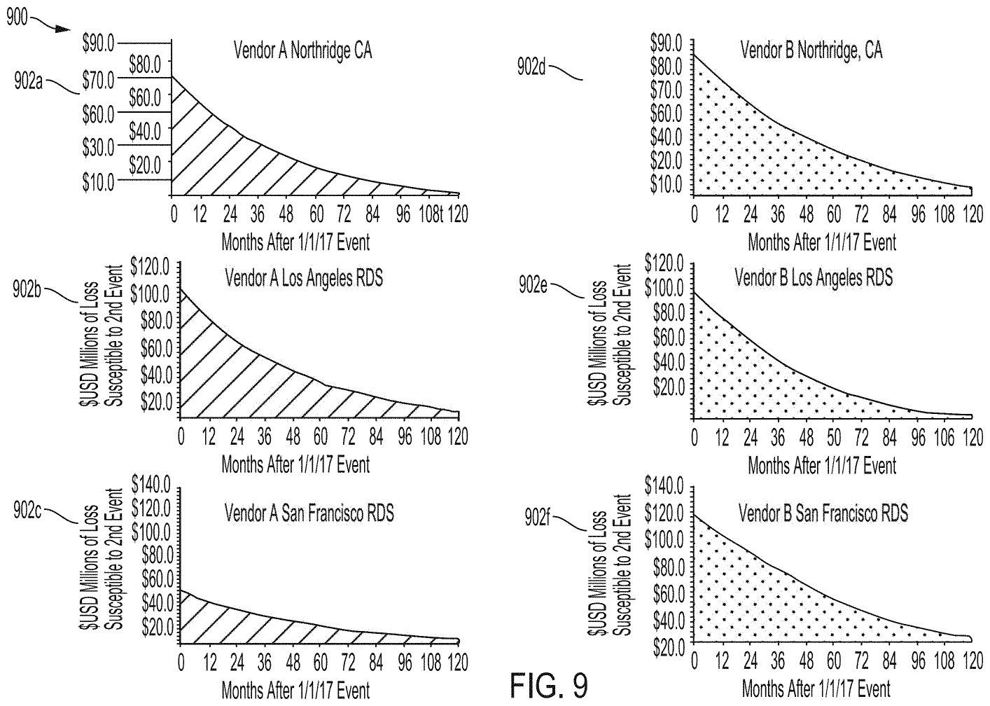

Another type of output UI screen generated by the front-end driver engine 140 in real-time from a loss matrix 500 is a time series analysis UI screen 900 shown in FIG. 9. In some implementations, the time series analysis UI screen 900 may include one or more time analysis graphs 902 that display amounts of monetary loss susceptible to a second occurrence of a catastrophic event based an amount of time that has passed since an occurrence of a first catastrophic event. In some examples, the time analysis graphs 902 presented within the UI screen may represent various locations and/or vendor models. For example, graphs 902a-c represent catastrophic event models for a first catastrophic event model vendor (Vendor A), and graphs 902d-f represent catastrophic event models for a second catastrophic event model vendor (Vendor B). Further graphs 902a,d represent time analysis graphs for Northridge, Calif., graphs 902b,e represent time analysis graphs for Los Angeles, Calif., and graphs 902c,f represent time analysis graphs for San Francisco, Calif.

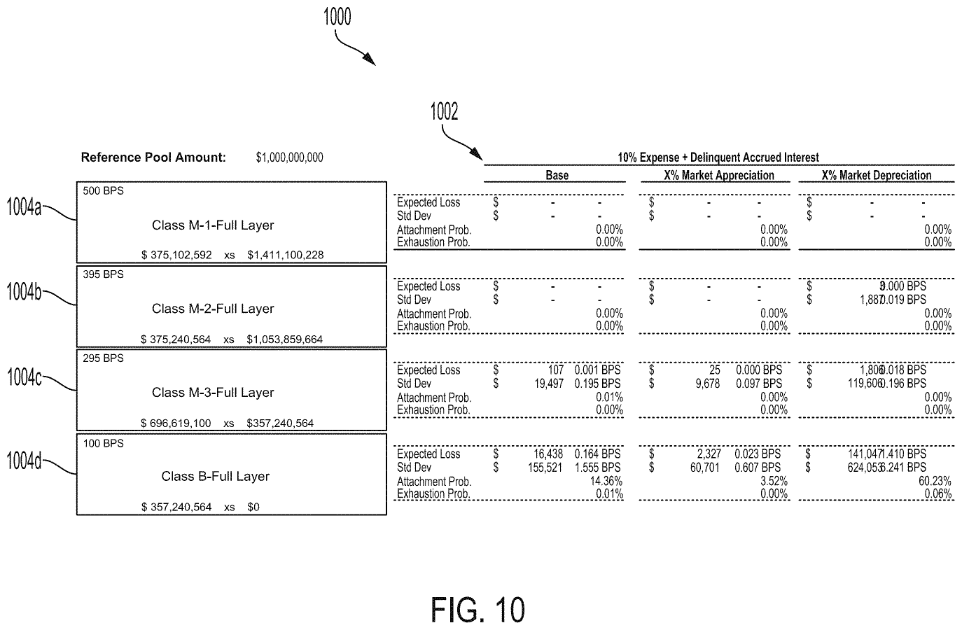

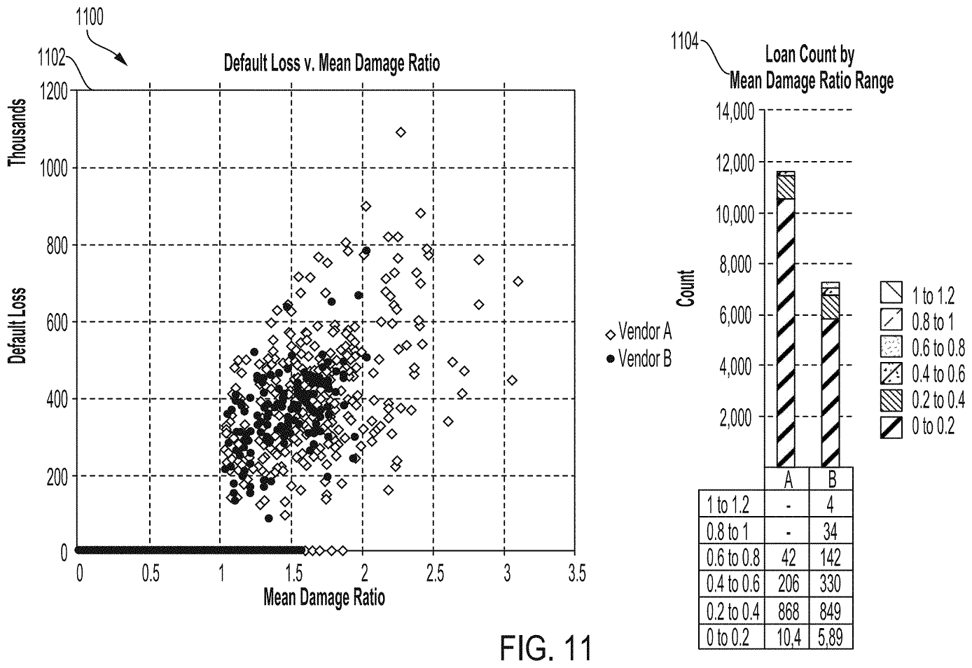

FIG. 10 shows another type of output UI screen 1000 generated by the front-end driver engine 140 in real-time from a loss matrix 500, which is a credit loss UI screen 1000 for reinsurance layers. In some implementations, the credit loss UI screen 1000 may portray loss statistics for one or more HPI scenarios 1002 for at a number of tiered reinsurance layers 1004. FIG. 11 shows yet another type of output UI screen 1100 generated in real-time by the front-end driver engine 140 which provides statistical correlation analysis between catastrophic event model vendors, which allows users to compare different catastrophic event model vendors. In some implementations, the UI screen 1100 may include a graph 1102 that displays default loss versus mean damage ratio for multiple model vendors to allow users to see the variations in predicted losses between each of the vendors. The UI screen 1100 may also include a loan count bar graph 1104 that allows users to see the number of loans that fall within various ranges of mean damage ratios for each of the model vendors.

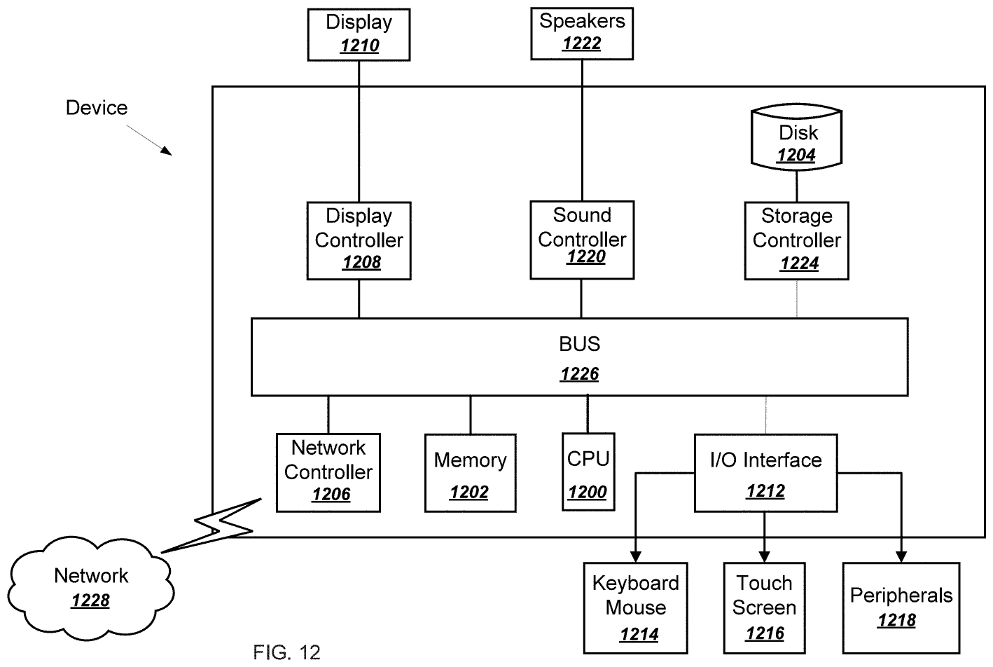

Next, a hardware description of the computing device, mobile computing device, or server according to exemplary embodiments is described with reference to FIG. 12. The computing device, for example, may represent the external entities 104, the insurance providers 102, the mortgage providers 106, or one or more computing systems supporting the functionality of the catastrophic loss determination system 110, as illustrated in FIG. 1. In FIG. 12, the computing device, mobile computing device, or server includes a CPU 1200 which performs the processes described above. The process data and instructions may be stored in memory 1202. The processing circuitry and stored instructions may enable the computing device to perform, in some examples, the method 300 of FIG. 3. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer. The storage medium disk 1204, in some examples, may store the contents of the data repository 116 of FIG. 1, as well as the data maintained by the external entities 104, the insurance providers 102, and the mortgage providers 106 prior to accessing by the catastrophic loss determination system 110 and transferring to the data repository 116.

Further, a portion of the claimed advancements may be provided as a utility application, background daemon, or component of an operating system, or combination thereof, executing in conjunction with CPU 1200 and an operating system such as Microsoft Windows 10, UNIX, Solaris, LINUX, Apple MAC-OS and other systems known to those skilled in the art.

CPU 1200 may be a Xeon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the inventive processes described above.

The computing device, mobile computing device, or server in FIG. 12 also includes a network controller 1206, such as an Intel Ethernet PRO network interface card from Intel Corporation of America, for interfacing with network 1228. As can be appreciated, the network 1228 can be a public network, such as the Internet, or a private network such as an LAN or WAN network, or any combination thereof and can also include PSTN or ISDN sub-networks. The network 1228 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known. The network 1228, for example, may support communications between the catastrophic risk determination system 110 and any one of the external entities 104, insurance providers 102, and mortgage providers 106.

The computing device, mobile computing device, or server further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard. The display controller 1208 and display 1210 may enable presentation of the user interfaces illustrated, in some examples, in FIG. 2 and FIGS. 6A-11.

A sound controller 1220 is also provided in the computing device, mobile computing device, or server, such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device, mobile computing device, or server. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

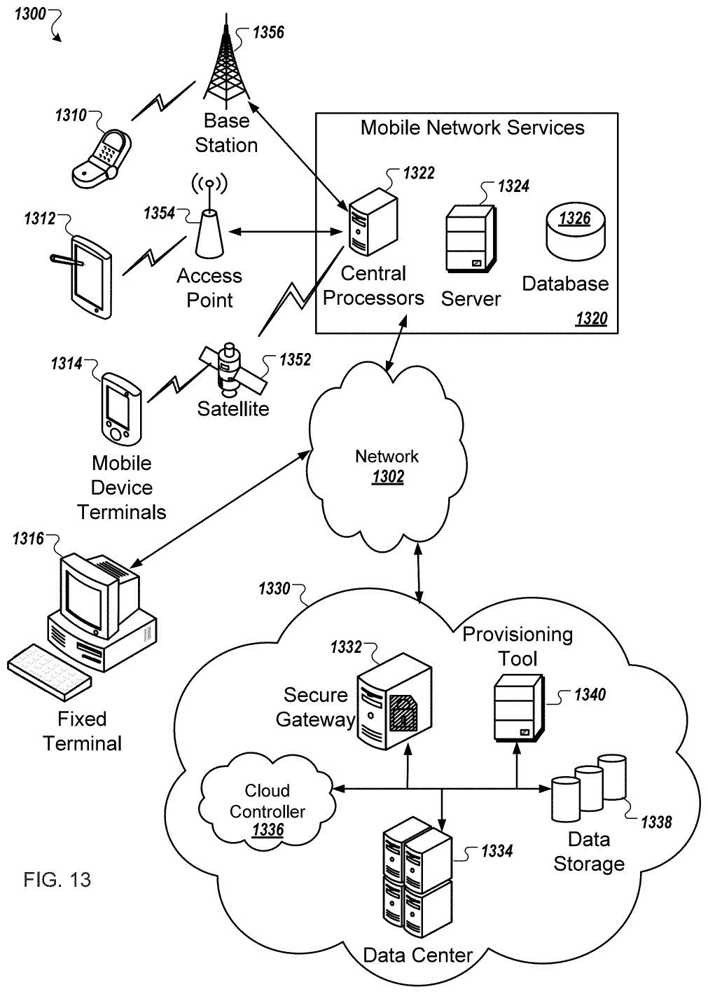

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 13, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1330, such as Google Cloud Platform™ to perform at least portions of methods or algorithms detailed above. The processes associated with the methods described herein can be executed on a computation processor, such as the Google Compute Engine by data center 1334. The data center 1334, for example, can also include an application processor, such as the Google App Engine, that can be used as the interface with the systems described herein to receive data and output corresponding information. The cloud computing environment 1330 may also include one or more databases 1338 or other data storage, such as cloud storage and a query database. In some implementations, the cloud storage database 1338, such as the Google Cloud Storage, may store processed and unprocessed data supplied by systems described herein. For example, the client exposure data 150, catastrophic event models 152, GUI templates 156, property value data 158, mortgage data 160, geocoded data 164, and/or loss statistics 166 may be maintained by the catastrophic loss determination system 110 of FIG. 1 in a database structure such as the databases 1338.

The systems described herein may communicate with the cloud computing environment 1330 through a secure gateway 1332. In some implementations, the secure gateway 1332 includes a database querying interface, such as the Google BigQuery platform. The data querying interface, for example, may support access by the catastrophic risk determination system 110 to data stored on any one of the external entities 104, insurance providers 102, and mortgage providers 106.

The cloud computing environment 1330 may include a provisioning tool 1340 for resource management. The provisioning tool 1340 may be connected to the computing devices of a data center 1334 to facilitate the provision of computing resources of the data center 1334. The provisioning tool 1340 may receive a request for a computing resource via the secure gateway 1332 or a cloud controller 1336. The provisioning tool 1340 may facilitate a connection to a particular computing device of the data center 1334.

A network 1302 represents one or more networks, such as the Internet, connecting the cloud environment 1330 to a number of client devices such as, in some examples, a cellular telephone 1310, a tablet computer 1212, a mobile computing device 1214, and a desktop computing device 1316. The network 1302 can also communicate via wireless networks using a variety of mobile network services 1320 such as Wi-Fi, Bluetooth, cellular networks including EDGE, 3G and 10G wireless cellular systems, or any other wireless form of communication that is known. In some examples, the wireless network services 1320 may include central processors 1322, servers 1324, and databases 1326. In some embodiments, the network 1202 is agnostic to local interfaces and networks associated with the client devices to allow for integration of the local interfaces and networks configured to perform the processes described herein. Additionally, external devices such as the cellular telephone 1310, tablet computer 1312, and mobile computing device 1314 may communicate with the mobile network services 1320 via a base station 1356, access point 1354, and/or satellite 1352.

Aspects of the present disclosure are directed to systems and methods for determining potential losses due to occurrences of catastrophic events, which can be used to determine costs associated with losses due to mortgage defaults from damage to properties caused by the catastrophic events. In some implementations, the information generated by a catastrophic loss determination system can be used to determine a severity associated with property owners defaulting on mortgages due to physical damage to a property caused by a catastrophic event. In some examples, the mortgage default severity determinations may be made based on a set of logical assumptions associated with mortgage default frequency based on physical loss modeling outputs received from catastrophic modeling vendors. In some implementations, the catastrophic loss determination system can dynamically present one or more user interface screens to a user in real-time that include loss statistics customized to a portfolio of locations, such as mortgaged properties. In some examples, the user interface screens are generated from a set of loss statistics that are calculated for the portfolio.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

1. A system comprising:
processing circuitry; and
a non-transitory computer readable memory coupled to the processing circuitry, the memory storing machine-executable instructions, wherein the machine-executable instructions, when executed on the processing circuitry, cause the processing circuitry to
receive, from a remote computing device of a user via a network, a loss determination query for a location, wherein
the loss determination query includes a request for an assessment of mortgage default risk for a plurality of properties in a portfolio data set of the user within the location related to a type of catastrophic event,
wherein the portfolio data set includes characteristics of one or more mortgaged properties, and
wherein the type of catastrophic event is a potentially occurring catastrophic event, and
the loss determination query includes one or more loss input parameters for customizing the assessment to preferences of the user, the one or more loss input parameters including the type of catastrophic event, one or more preferred catastrophic risk models of the user, and a storage location of the portfolio data set within a non-transitory data storage region,
compute, for each of the one or more preferred catastrophic risk models for the type of catastrophic event, estimated losses for each of the plurality of properties in the portfolio data set within the location due to at least one occurrence of the type of catastrophic event, wherein the estimated losses are computed based on the respective preferred catastrophic risk model for the type of catastrophic event, and wherein the portfolio data set is accessed from the storage location in the non-transitory data storage region,
generate, from the estimated losses for each of the plurality of properties in the portfolio data set, a loss vector for the user representing risk exposure to the plurality of properties in the portfolio data set from the type of catastrophic event, wherein generating the loss vector comprises customizing one or more loss vector entries to the user based on the one or more loss input parameters,
determine, for each of the plurality of properties and each of the one or more preferred catastrophic risk models, a respective mortgage default risk based on a comparison of each of the estimated losses in the loss vector to at least one of an equity position, a property value, and an unpaid mortgage principal balance for the respective property, wherein the mortgage default risk represents an amount of impact of physical damage to the respective property from the type of catastrophic event on a likelihood of mortgage default for the respective property, and
generate, in real-time from the loss vector and the respective determined mortgage default risks for each of the plurality of properties responsive to receiving the loss determination query, one or more loss estimation user interface screens presenting the mortgage default risk and the estimated losses for the plurality of properties in the portfolio data set, wherein the one or more loss estimation user interface screens present a portion of the one or more loss vector entries to the remote computing device of the user such that the one or more loss estimation user interface screens are customized to the one or more loss input parameters.

2. The system of claim 1, wherein the loss vector comprises, for each of the plurality of properties, entries representing the estimated losses including at least one of a location identification, types of the one or more preferred catastrophic risk models, an event loss amount, a physical damage amount, expense loss amounts at one or more percentage tiers, and an amount of interest loss.

3. The system of claim 2, wherein the physical damage amount comprises a land damage portion and a building damage portion.

4. The system of claim 2, wherein generating the loss vector for each of the plurality of properties in the portfolio data set comprises generating appreciated or depreciated values for the event loss amount, the physical damage amount, the expense loss amounts, and the amount of interest lost for the respective property, wherein
the appreciated or depreciated values represent a scaled change in value of the respective property.

5. The system of claim 1, wherein determining the mortgage default risk for each of the plurality of properties comprises anticipating a default when an amount of physical damage to the respective property is greater than a first predetermined threshold of the property value and greater than a second predetermined threshold of the equity position.

6. The system of claim 1, wherein each of the one or more preferred catastrophic risk models for the type of catastrophic risk corresponds to a different catastrophic risk model vendor.

7. The system of claim 1, wherein the type of catastrophic event is one of a plurality of types of catastrophic events including one or more of a hurricane, a tornado, a flood, a wild fire, an earthquake, and a terrorist attack

8. The system of claim 1, wherein the user comprises at least one of an insurance provider and a mortgage provider.

9. The system of claim 1, wherein generating the loss estimation user interface screen comprises presenting the estimated losses and mortgage default risk for the plurality of properties within a geocoded representation of the location.

10. The system of claim 9, wherein the estimated losses and the mortgage default risk for each of the plurality of properties are represented within the one or more loss estimation user interface screens as color coded data points within the geocoded representation of the location.

11. The system of claim 1, wherein generating the one or more loss estimation user interface screens comprises presenting a comparison of the estimated losses and the mortgage default risk for each of the one or more preferred catastrophic risk models.

12. A method comprising:
receiving, from a remote computing device of a user via a network, a loss determination query for a location of a plurality of entities in a portfolio data set of the user within the location related to a type of catastrophic event,
wherein the portfolio data set includes characteristics of one or more mortgaged entities,
wherein the type of catastrophic event is a potentially occurring catastrophic event, and
wherein the loss determination query includes one or more loss input parameters for customizing a loss determination assessment to preferences of the user, the one or more loss input parameters including the type of catastrophic event, one or more preferred catastrophic risk models of the user, and a storage location of the portfolio data set within a non-transitory data storage region;
computing, by processing circuitry for each of the one or more preferred catastrophic risk models for the type of catastrophic event, estimated losses for each of the plurality of entities in the portfolio data set within the location due to at least one occurrence of the type of catastrophic event, wherein
wherein the estimated losses are computed based on the respective preferred catastrophic risk model for the type of catastrophic event, and
wherein the portfolio data set is accessed from the storage location in the non-transitory data storage region;
generating, by the processing circuitry from the estimated losses for each of the plurality of entities in the portfolio data set, a loss vector for the user representing risk exposure to the plurality of entities from the type of catastrophic event, wherein
generating the loss vector comprises customizing one or more loss vector entries to the user based on the one or more loss input parameters;
determining, by the processing circuitry for each of the plurality of entities and each of the one or more preferred catastrophic risk models, a respective mortgage default risk based on a comparison of each of the estimated losses in the loss vector to at least one of an equity position, an entity value, and an unpaid mortgage principal balance for the respective entity, wherein the mortgage default risk represents an amount of impact of physical damage to the respective entity from the type of catastrophic event on a likelihood of mortgage default for the respective entity; and
generating, by the processing circuitry in real-time from the loss vector and the respective determined mortgage default risks for each of the plurality of entities responsive to receiving the loss determination query, one or more loss estimation user interface screens presenting the mortgage default risk and the estimated losses for the plurality of properties in the portfolio data set, wherein the one or more loss estimation user interface screens present a portion of the one or more loss vector entries to the remote computing device of the user such that the one or more loss estimation user interface screens are customized to the one or more loss input parameters.

13. The method of claim 12, wherein the plurality of entities correspond to one or more insured locations associated with the user.

14. The method of claim 12, wherein the loss vector comprises, for each of the plurality of entities, entries representing the estimated losses including at least one of a location identification, types of the one or more preferred catastrophic risk model models, an event loss amount, a physical damage amount, expense loss amounts at one or more percentage tiers, and an amount of interest loss.

15. The method of claim 14, wherein generating the loss vector for each of the plurality of entities in the portfolio data set comprises generating appreciated or depreciated values for the event loss amount, the physical damage amount, the expense loss amounts, and the amount of interest lost, wherein
the appreciated or depreciated values represent a scaled change in value of the respective entity of the plurality of entities.

16. The method of claim 12, wherein determining the mortgage default risk for each of the plurality of entities comprises anticipating a default when an amount of physical damage to the respective entity is greater than a first predetermined threshold of the entity value and greater than a second predetermined threshold of the equity position.

17. The method of claim 12, wherein each of the one or more preferred catastrophic risk models for the type of catastrophic risk corresponds to a different catastrophic risk model vendor.

18. The method of claim 12, wherein generating the one or more loss estimation user interface screens comprises presenting the estimated losses and the mortgage default risk for the plurality of entities within a geocoded representation of the location.

19. The method of claim 18, wherein the estimated losses and the mortgage default risk for each of the plurality of entities are represented within the one or more loss estimation user interface screens as color coded data points within the geocoded representation of the location.

20. The method of claim 12, wherein the user comprises at least one of an insurance provider and a mortgage provider.
